(19) United States
(12) Patent Application Publication
(10) Pub. No.: US 2004/0251123 A1
(43) Pub. Date: Dec. 16, 2004

(54) Stratified discharge for dissociation of electronegative molecular gas

(76) Inventor: Tihiro Ohkawa, La Jolla, CA (US)

Correspondence Address: Attn: NEIL K. NYDEGGER, NYDEGGER & ASSOCIATES, 348 Olive Street, San Diego, CA, 92103, US

(21) Appl. No.: 10/459,270

(22) Filed: Jun. 11, 2003

(51) Int. Cl. H05F 3/00; B01J 19/08; B01J 19/12

(52) U.S. Cl. 204/164; 422/186.04

(57) ABSTRACT

A device for dissociating an electronegative molecular gas includes a cylindrical-shaped tube having a wall that surrounds a discharge chamber. A first injector is positioned to introduce the molecular gas into a central region of the discharge chamber. A second injector is positioned to introduce an atomic gas, such as Argon, into an annular region between the central region and the tube wall. An induction coil is mounted on the wall and energized. This ionizes the atomic gas and creates a plasma discharge in the annular region. Electrons liberated by the discharge interact with the molecular gas at the interface layer between the molecular and atomic gases, dissociating the molecular gas. The interaction between the plasma discharge and the electronegative molecular gas is substantially limited to the interface layer to avoid quenching of the plasma discharge. In one application, the device is used to recover Fluorine from Uranium Hexafluoride (UF₆).

### FIELD OF THE INVENTION

The present invention pertains generally to devices for dissociating an electronegative, molecular gas. More particularly, the present invention pertains to devices for recovering Fluorine gas from an electronegative Fluoride, such as Uranium Hexafluoride. The present invention is particularly, but not exclusively, useful for recovering Fluorine gas from Uranium Hexafluoride using an inductively coupled plasma (ICP) torch.

### BACKGROUND OF THE INVENTION

Uranium Hexafluoride (UF₆) is available as a by-product of the conventional extraction process used to produce Uranium 235. If an efficient process were available, it would be desirable to recover Fluorine gas from Uranium Hexafluoride for use in a variety of applications. It happens that Fluorides, such as Uranium Hexafluoride and Sulfur Hexafluoride, are highly electronegative (i.e. their ability to retain or gain electrons is relatively strong as compared to other molecules) and, thus, are hard to ionize using conventional methods. In fact, highly electronegative gases, such as Sulfur Hexafluoride, are often used in applications in which it is desirable to prevent electrical breakdown.

Although attempts have been made to recover Fluorine by ionizing and dissociating Uranium Hexafluoride in a plasma, these efforts have failed to produce an efficient recovery method because of the electronegativity of Uranium Hexafluoride. In greater detail, the introduction of Fluorides into a plasma has typically resulted in the quenching of the plasma due to the large electron appetite of the highly electronegative Fluoride. Specifically, when an electron encounters a Fluoride, such as UF₆, the following reactions are possible:

UF_{6+e→UF}₅+F+3.4 eV

UF_{6+e→UF}₅+F⁻+2.4 eV

UF₆+e→UF₅+F+e−0.96 eV

The first two of the above reactions are exothermic and are expected to have a higher reaction rate than the last one which is endothermic. Insofar as Fluorides are concerned, the electron affinities of species of interest are UF₆⁻>5.1 eV, UF₅⁻=4.4 eV and F⁻=3.4 eV. For these species, once they are ionized, when the negative ion species encounter positive ions in the plasma, they will lose the attached electrons to the positive ions. For example, in an Argon discharge,

UF₅⁻+Ar⁺→UF₅+Ar+11.3 eV

F⁻+Ar+→F+Ar+12.3 eV.

In each case, the reaction energy is carried by the neutral products and is lost from the plasma.

The above process is then continued with UF₅ being negatively ionized through a dissociative attachment and producing UF₄⁻, followed by electron loss to produce UF₄. This continues until the UF₆ is completely dissociated:

6[Ar^{++e]+UF}₆→U+6F+6Ar+68 eV.

The above processes show that UF₆ has a huge appetite for electrons and power. Thus, if a relatively small amount of UF₆ is introduced into a discharge of Argon, for example, the discharge may be able to supply extra electrons and power and survive. However, the dispersion of any significant amount of Uranium Hexafluoride into the Argon discharge is likely to quench the discharge. This is especially true for a discharge that is generated using an inductively coupled plasma (ICP) torch, in which the only source of electrons arises from the ionization of the discharge gas (i.e. Argon). Although a D.C. torch has the potential to supply additional electrons from the cathode of the D.C. torch, evaporative losses from the cathode can complicate the Fluorine recovery process. Specifically, materials evaporated from the cathode, such as carbon, can combine with fluorine, for example, producing fluorocarbons and lowering Fluorine yields.

In light of the above, it is an object of the present invention to provide devices and methods suitable for the purposes of dissociating an electronegative, molecular gas. It is another object of the present invention to provide devices and methods for recovering Fluorine gas from an electronegative Fluoride, such as Uranium Hexafluoride or Sulfur Hexafluoride. It is yet another object of the present invention to provide devices and methods for dissociating an electronegative molecular gas that are easy to use, relatively simple to implement, and comparatively cost effective.

### SUMMARY OF THE INVENTION

The present invention is directed to a device for dissociating an electronegative molecular gas. In one application of the present invention, the device can be used to recover Fluorine gas from an electronegative Fluoride, such as Uranium Hexafluoride or Sulfur Hexafluoride. To do this, the device for the present invention includes a cylindrical-shaped hollow tube having a wall that surrounds a discharge chamber. Also, the cylindrical-shaped tube extends from a first open end to a second open end and defines a longitudinal axis.

The device further includes a first injector that is positioned at the first end of the tube. Specifically, the first injector is oriented to introduce the electronegative, molecular gas along the longitudinal axis and into a central region of the discharge chamber. A second injector is also positioned at the first end of the tube. This second injector is oriented to introduce an atomic gas, such as Argon, into an annular region of the discharge chamber that extends between the central region and the wall of the tube.

For the present invention, an induction coil is mounted on the wall of the tube to ionize the atomic gas, and thereby create a discharge in the annular region. With this cooperation of structure, an azimuthally oriented electric field and current are established. A consequence of this is that electrons liberated by the discharge in the annular region interact with the molecular gas at an interface layer that is established between the molecular and atomic gases. Because this interaction is substantially limited to the interface layer, only a fraction of the electronegative molecular gas interacts with the free electrons at any one time. Thus, the rapid consumption of the free electrons by the electronegative molecular gas that would otherwise quench the plasma discharge is avoided. In accordance with the present invention, in order to ensure that the interaction between electrons and the electronegative gas is limited to the interface layer, the flow rate of the electronegative gas is controlled. Specifically, this is done to substantially prevent turbulent flow in the electronegative, molecular gas, and to thereby avoid the mixing action inside the discharge chamber that would otherwise disrupt the interface layer.

At the relatively stable interface layer, the electrons interact with the electronegative molecular gas to form negative ions (e.g. UF₅⁻) via the process of dissociative attachment. These negative ions, in turn, will charge exchange with positive ions in the plasma (e.g. Ar⁺). After a series of such reactions (i.e. dissociative attachment followed by charge exchange), the molecular gas (e.g. UF₆) is completely dissociated (e.g. U+6F). In this process, the length of the tube is sized relative to the flow rates of the input gases to ensure that complete dissociation of the electronegative molecular gas occurs within the tube. The dissociation products then exit through the second end of the tube where one or more of the dissociation products (e.g. Fluorine gas) can be recovered.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a device for dissociating an electronegative molecular gas; and

FIG. 2 is a cross sectional view of the device shown in FIG. 1 as seen along line 2-2 in FIG. 1.

### DESCRIPTION OF THE PREFERRED EMBODIMENTS

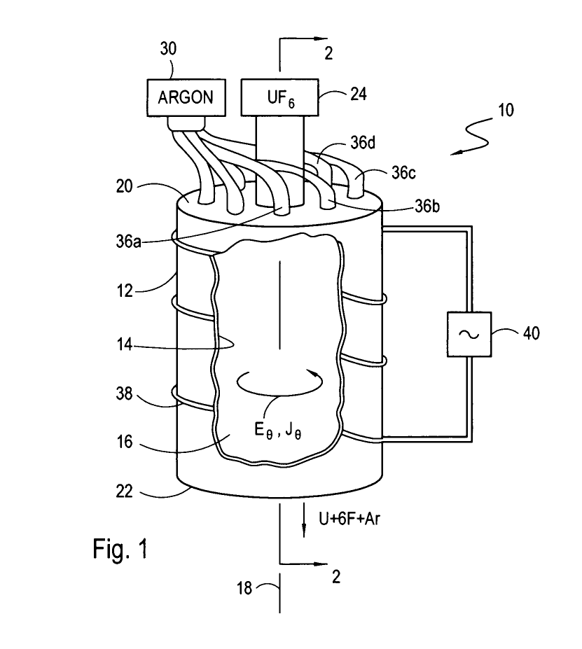

Referring initially to FIG. 1, a device for dissociating an electronegative, molecular gas, such as Uranium Hexafluoride, is shown and generally designated 10. As shown in FIG. 1, the device 10 includes a tube 12 that is typically cylindrical-shaped and hollow. As further shown, the tube 12 has a wall 14 that surrounds a discharge chamber 16 and defines a longitudinal axis 18. It can be further seen that the tube 12 extends axially from a first end 20 to a second end 22.

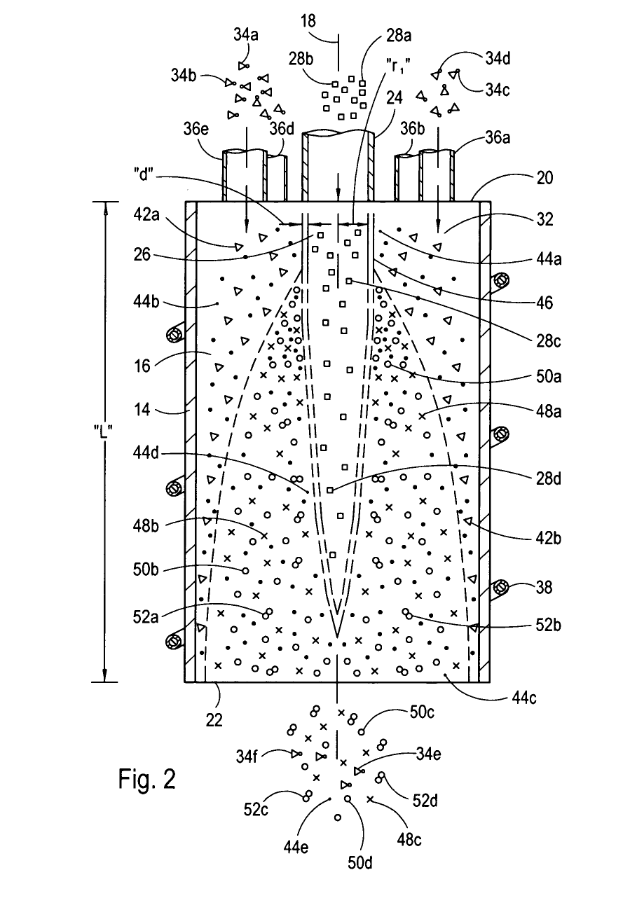

FIG. 1 further shows that the device 10 includes a first injector 24 that is positioned at the first end 20 of the tube 12 and oriented to introduce the electronegative, molecular gas, in this case Uranium Hexafluoride gas, into the discharge chamber 16. As best seen in FIG. 2, the Uranium Hexafluoride gas is introduced along the longitudinal axis 18 and into a central region 26 of the discharge chamber 16 (note: exemplary Uranium Hexafluoride molecules have been shown as squares and selected Uranium Hexafluoride molecules have been identified with reference numerals 28a-d).

Although the device 10 is herein shown and described in a process application wherein Uranium Hexafluoride is completely dissociated and Fluorine recovered, it is to be appreciated that other materials, including other electronegative Fluorides such as Sulfur Hexafluoride, could be dissociated in the device 10, in place of Uranium Hexafluoride. It is to be further appreciated that the device 10 could be used to partially dissociate a material, or dissociate a portion of a material, if desired. However, as implied above, the device 10 is particularly useful for dissociating materials which are electronegative, or materials which react to become electronegative after introduction into the discharge chamber 16.

FIG. 1 further shows that the device 10 includes a second injector 30 that is positioned at the first end 20 of the tube 12 and configured to introduce an atomic gas, in this case Argon gas, into the discharge chamber 16. As best seen in FIG. 2, the Argon gas is introduced into an annular region 32 of the discharge chamber 16 that extends between the central region 26 and the wall 14. (note: exemplary Argon gas particles have been shown as triangles coupled to dots and selected Argon gas particles have been identified with reference numerals 34a-d). FIGS. 1 and 2 show that the injector 30 includes eight injector lines (of which exemplary lines 36a-e have been labeled) to uniformly introduce the Argon gas into the annular region 32. Although a plurality of injector lines 36 that are positioned uniformly around the periphery of the end 20 have been shown for the device 10, it is to be appreciated that other structures known in the pertinent art to uniformly introduce a gas into an annular region, such as annular region 32, can be used in the device 10.

As further shown in FIGS. 1 and 2, the device 10 includes an induction coil 38 that is mounted on the wall 14 to ionize the atomic gas (e.g. Argon) and create a discharge in the annular region 32 of the discharge chamber 16. As shown in FIG. 1, the induction coil 38 includes an RF generator 40. With this cooperation of structure, an azimuthally oriented electric field, E_{θ} and a corresponding azimuthally oriented current, J_{θ} are established in the discharge chamber 16.

Continuing with FIG. 2, the discharge in the annular region 32 creates Argon ions (note: exemplary Argon ions have been shown as triangles and selected Argon ions have been identified with reference numerals 42a and 42b) and free electrons (note: exemplary free electrons have been shown as solid dots and selected electrons have been identified with a reference numeral 44a-d). These free electrons, such as electron 44a, in the annular region 32 interact with the Uranium Hexafluoride molecules, such as Uranium Hexafluoride molecule 28c, at an interface layer 46 between the central region 26 and the annular region 32. Because this interaction is substantially limited to the interface layer 46, only a fraction of the Uranium Hexafluoride molecules 28a-d interact with free electrons 44a-d, at any one time. Thus, the rapid consumption of the free electrons 44a-d by the Uranium Hexafluoride molecules 28a-d that could quench the Argon discharge is obviated. As described in greater detail below, to ensure the interaction between electrons 44a-d and the Uranium Hexafluoride molecules 28a-d is limited to the interface layer 46, the flow rate of the Uranium Hexafluoride molecules 28a-d into the discharge chamber 16 is controlled to prevent turbulent flow of the Uranium Hexafluoride gas and its associated mixing action.

Within the interface layer 46, electrons, such as electron 44a, interact with the Uranium Hexafluoride molecules, such as Uranium Hexafluoride molecule 28c, to form negative ions (e.g. UF₅⁻) via the process of dissociative attachment. The negative ions, in turn, charge exchange with Argon ions, such as Argon ion 42a in the interface layer 46. After a series of such reactions (i.e. dissociative attachment followed by charge exchange), a portion of the Uranium Hexafluoride molecules, including Uranium Hexafluoride molecule 28c, is completely dissociated.

As shown in FIG. 2, the dissociation creates a boundary region downstream from the first end 20 that contains Uranium ions, Fluorine atoms and ions (F, F+) and electrons, such as electrons 44c and 44d (note: Uranium ions have been illustrated using the x symbol and selected Uranium ions have been identified with reference numerals 48a and 48b, Fluorine ions, F+, have been shown as small circles and selected Fluorine ions have been identified with reference numerals 50a-d and Fluorine gas particles, F, have been illustrated using the double circle symbol and selected Fluorine gas particles have been identified with reference numerals 52a-d). Because this boundary region is not electronegative, the discharge extends into the boundary region. More specifically, the ionization potential of U is much lower than the ionization potential of either F or Ar, and thus the degree of ionization in the boundary region will be higher than in the region containing Argon ions 42a,b. At points downstream from where the boundary region begins, electrons in the boundary region, such as electron 44d, interact with the Uranium Hexafluoride molecules such as Uranium Hexafluoride molecule 28d, in an interface layer between the central region 26 and the boundary region, to dissociate a portion of the Uranium Hexafluoride molecules, including Uranium Hexafluoride molecule 28d, via the dissociative attachment followed by charge exchange reaction described above.

With continued reference to FIG. 2, it can be seen that the boundary region expands in a direction downstream from the first end 20 at the expense of both the central region 26 and the region containing Argon ions 42a,b. The expansion is due in part to the depletion of Uranium Hexafluoride molecules 28a-d, and the seven fold molar increase that accompanies the dissociation. As further shown in FIG. 2, the expansion of the boundary region in a direction downstream from the first end 20 continues until all of the Uranium Hexafluoride molecules 28a-d have been dissociated. After complete dissociation, reaction products that include Uranium ions 48c, Fluorine ions 50c,d, electrons 44e, Fluorine particles 52c,d, and Argon gas particles 34e,f, exit the discharge chamber 16. Reaction products exiting the device 10 can be separated, for example to recover Fluorine gas, using a separation device (not shown) such as a Plasma Mass Filter as disclosed and claimed in U.S. Pat. No. 6,096,220, which issued on Aug. 1, 2000 to Ohkawa. U.S. Pat. No. 6,096,220 is hereby incorporated by reference.

Characteristics of the interface layer 46 can be analyzed as follows. In the interface layer 46, electrons, such as electron 44a, interact with the Uranium Hexafluoride molecules, such as Uranium Hexafluoride molecule 28c, to form negative ions (e.g. UF₅⁻) via the process of dissociative attachment. The negative ions, in turn, charge exchange with Argon ions, such as Argon ion 42a in the interface layer 46. The net result is the extinction of the plasma and the dissociation of the Fluoride molecules. For UF₆, six steps are needed to complete the dissociation. By balancing the diffusive transport and the extinction rate, the thickness, d, of the interface layer 46 is given by:

d^{2˜D}_{0/[K}_{DA n}ᵢ]

where K_{DA} is the dissociative attachment rate, nᵢ is the plasma density and the diffusion coefficient D₀ is given by:

D₀≈v/[σ₀n₀]

where “v” is the thermal velocity, “σ₀” is the neutral-neutral collision cross section and “n₀” is the neutral density. In contrast to the diffusive mixing, the thickness, d, of the interface layer 46 does not increase over time.

Also, if the initial position of the interface layer 46 is radially distanced at a radius r=r₁ from the axis 18, (i.e. “r₁” is the radial extent of said central region 26 at said first end 20) the time τ_{D} for the complete dissociation of the molecular gas is given by:

τ_{D}˜2r₁/[Iv_{M}]

where “I” is the degree of ionization and “Vₘ” is the thermal velocity of said molecular gas. By choosing τ_{D}<τ, complete dissociation of the Uranium Hexafluoride molecules, such as Uranium Hexafluoride molecule 28c, occurs in the discharge chamber 16.

As indicated above, the flow rate of the Uranium Hexafluoride molecules 28a-d into the discharge chamber 16 is controlled to substantially prevent turbulent flow of the Uranium Hexafluoride gas and the resultant associated mixing action that would otherwise occur. By preventing this mixing action, the interaction between electrons 44a-d and the Uranium Hexafluoride molecules 28a-d is substantially limited to the interface layer 46, and a quenching of the discharge is prevented. The transition from the laminar to the turbulent flow occurs when the Reynolds number R, defined by:

R=a u/D

exceeds 1000, where “a” is the radius, “u” is the velocity of gas flow.

For a mixing length, dₘ, during a residence time τ, the diffusion coefficient is:

D₀˜dₘ²/τ

thus:

R=L a/dₘ²

where “L” is the length of the tube, and “dₘ” is the mixing length. The condition of laminar flow is given by:

[L/a][a/dₘ]²<1000.

For example, conditions of L/a=10 and a/dₘ=5 ensure laminar flow in the discharge chamber 16.

The generation of seven moles of gas (i.e. U+6F) per mole of the molecular gas (i.e. UF₆) causes the pressure to increase as the gases proceed downstream from the end 20 of the tube 12. By constructing a simplified 1-D model, the effect of the dissociation can be estimated. Assuming that the atoms produced by the dissociation have the same velocity and temperature as the gas flow, the continuity equation is given by:

d[n u ]/dz=S

where S is the source of atoms and is assumed to be uniform, and z is the distance in the axial direction. The equation of motion is given by:

M n u[d u/dz]=−d p/dz.

Assuming that the temperature is determined by the discharge and is constant, the above equations can be solved with the initial conditions at z=o; n=n₀ and u=u₀ to obtain:

[u²−u₀²]/2vₛ²=−1n{[Sz+n₀ u₀]/n₀ u}

[S z+n₀u₀]²/[n²vₛ²]=[u₀/vₛ]²−2 1n[n/n₀]

If slow-varying logarithmic terms are ignored, the density increases linearly with z, and the change in the velocity is small.

For an exemplary tube with L=0.5 m and a=5 cm at a gas pressure of 10 torr and injection velocity of 50 m/s, the calculated residence time is about 10 ms. Thus the conditions dₘ<a and R<10³ are met with dₘ˜1 cm and R˜200. In addition, the equations indicated that the condition τ_{D}<τ is satisfied if the degree of ionization is greater than about 2%.

While the particular stratified discharge for dissociation of electronegative molecular gases herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for dissociating a Fluoride gas which comprises:
a cylindrical-shaped hollow tube having a wall surrounding a discharge chamber, said tube defining a longitudinal axis and having a first end and a second end;
a first injector for introducing the Fluoride gas into a central region of said discharge chamber through said first end of said tube, wherein said central region is substantially centered on said axis;
a second injector for introducing an atomic gas into an annular region of said discharge chamber through said first end of said tube, wherein said annular region is established between said central region and said wall of said tube; and
an induction coil mounted on said wall of said tube to ionize said atomic gas in said annular region and produce electrons for interaction with said Fluoride gas, wherein said electrons cause said Fluoride gas to dissociate.

2. A device as recited in claim 1 wherein said atomic gas is Argon.

3. A device as recited in claim 1 wherein said Fluoride gas is Sulfur Hexafluoride (SF₆).

4. A device as recited in claim 1 wherein said Fluoride gas is Uranium Hexafluoride (UF₆).

5. A device as recited in claim 1 wherein said Fluoride gas is introduced into said central region with substantially laminar flow.

6. A device as recited in claim 5 wherein the Reynolds number (R) for the molecular gas is R≡au/D and [L/a][a/dₘ]²<1000; where “L” is the length of the tube, “a” is radius, and “dₘ” is the mixing length.

7. A device as recited in claim 5 wherein the time for dissociation “τ_{d}” is less than the residence time “τ” of gases in the discharge chamber (τ_{d}<τ) and wherein τ_{d}=2r₁[IVₘ] with “r₁” being the radial extent of said central region at said first end of said tube, “I” being the degree of ionization, and “Vₘ” being the thermal velocity of said molecular gas.

8. A device for dissociating a molecular gas, said device comprising:
a wall surrounding a discharge chamber;
means for introducing said molecular gas into a first region of said discharge chamber with a substantially laminar flow;
means for introducing an atomic gas into a second region of said discharge chamber wherein said second region is adjacent said first region to establish a substantially stable interface layer therebetween; and
means for ionizing said atomic gas to produce electrons for dissociating said molecular gas at said interface layer.

9. A device as recited in claim 8 wherein said molecular gas is Uranium Hexafluoride.

10. A device as recited in claim 8 wherein said molecular gas is Sulfur Hexafluoride.

11. A device as recited in claim 8 wherein said atomic gas is Argon.

12. A device as recited in claim 8 wherein said wall is formed as a substantially cylindrical shaped hollow tube.

13. A device as recited in claim 12 wherein said first region is cylindrical shaped and said second region is annular shaped.

14. A device as recited in claim 8 wherein said molecular gas is introduced into said first region with substantially laminar flow.

15. A method for dissociating an electronegative Fluoride, said method comprising the steps of:
providing a cylindrical-shaped hollow tube having a wall surrounding a discharge chamber, said tube defining a longitudinal axis and having a first end and a second end;
introducing said electronegative Fluoride into a central region of said discharge chamber through said first end of said tube, wherein said central region is substantially centered on said axis;
introducing an atomic gas into an annular region of said discharge chamber through said first end of said tube, wherein said annular region is established between said central region and said wall of said tube; and
establishing a substantially azimuthally oriented electric field in said discharge chamber to ionize said atomic gas in said annular region and produce electrons for dissociating said electronegative Fluoride.

16. A method as recited in claim 15 wherein said step of establishing a substantially azimuthally oriented electric field is accomplished using an induction coil.

17. A method as recited in claim 15 wherein said atomic gas is Argon.

18. A method as recited in claim 15 wherein said electronegative Fluoride is Sulfur Hexafluoride (SF₆).

19. A method as recited in claim 15 wherein said electronegative Fluoride is Uranium Hexafluoride (UF₆).

20. A method as recited in claim 15 wherein said electronegative Fluoride is introduced into said central region with substantially laminar flow.
